(19) United States
(12) Patent Application Publication
(10) Pub. No.: US 2014/0262005 A1
(43) Pub. Date: Sep. 18, 2014

(54) METHOD AND APPARATUS FOR PARTIALLY LAMINATING A COMPONENT, IN PARTICULAR A MOTOR VEHICLE COMPONENT

(71) Applicants: Etem Ibrahim Uysal, Viersen (DE); Werner Klusmeier, Lubbecke (DE)

(72) Inventors: Etem Ibrahim Uysal, Viersen (DE); Werner Klusmeier, Lubbecke (DE)

(73) Assignee: JOHNSON CONTROLS INTERIORS GMBH & CO. KG, Grefrath (DE)

(21) Appl. No.: 14/239,237

(22) PCT Filed: Aug. 16, 2012
(86) PCT No.: PCT/EP2012/066005

§ 371 Date: May 27, 2014

(30) Foreign Application Priority Data
Aug. 19, 2011 (DE) 10 2011 110 650.6

(51) Int. Cl. B32B 37/30

(52) U.S. Cl. CPC B32B 37/30
USPC 156/256; 156/322; 156/580; 156/510; 156/583.1

(57) ABSTRACT

The invention relates to a method and an apparatus at least for partially laminating a component (1), in particular of a motor vehicle, having a film (2) which is cut to a width which is selected to be slightly greater than a region (1.1) to be laminated of the component (1), wherein the film (2) is heated on both sides and is arranged in an upper die (4), wherein the component (1) is provided with an adhesive (6) and is arranged in a lower die (5), wherein the adhesive (8) is heated to be activated and a tool formed by the upper die (4) and the lower die (5) is closed for a pressing operation.

### BACKGROUND OF THE INVENTION

The invention relates to a method and an apparatus at least for partially laminating a component, in particular a vehicle component.

Instrument carrier panels or components of vehicle doors, in a comparatively large number of vehicle types, are conventionally laminated with films, in particular of polyvinyl chloride, of thermoplastic elastomers based on olefins and/or of thermoplastic polyurethane. In order to produce multiple colors and/or in order to use a variety of decorations and/or in order to laminate only specific regions of an instrument carrier panel or a component of a vehicle door, there are various possibilities. If the component, in particular the vehicle door, is formed from a number of individual components, the individual components are laminated separately and subsequently assembled by means of adhesive bonding and/or welding to form the vehicle door. Alternatively, the component is laminated with a film, wherein the region which is intended to have a different decoration and/or a different color is laminated separately in a subsequent step. This subsequent lamination of a region, for example a central field of the component of the vehicle door, is referred to as stamp lamination, or also specifically for the central field, as groove lamination. In the above-mentioned conventional methods of lamination, the individual components are laminated separately and joined together or the component is completely laminated as a whole, and the region which is intended to be provided with a different pattern and/or a different color is additionally provided with a corresponding film or another surface material, whereby a so-called material doubling is formed. In these two methods, significantly more material, in particular film, is used than can be visually perceived after the lamination.

DE 102 35 406 A1 discloses a method for the production of a plastics pressing skin, the use of the method for producing trim components for the motor vehicle interior and the trim components which can be obtained in this manner. The method makes provision for a plastics pressing material to be introduced into a pressing tool, wherein the pressing tool has a lower mold portion which is formed with a mold cavity and upper mold portion. The plastics pressing material is introduced into the open pressing tool, the pressing tool is closed and the plastics pressing material is distributed in the mold cavity by the tool travel.

DE 10 2005 023 945 A1 further describes a method for producing multicolored interior fitting components of motor vehicles having a defined surface profile, and the interior fitting components obtained in this manner having a component carrier and at least two decorative layers each having a defined surface and/or color decoration. In a first step of the method, the respective visible side of the respective decorative layer is heated to a desired grain temperature in the range from 180° C. to 220° C. and the rear sides of the decorative layers are heated to the respective deformation temperatures in the range from 130° C. to 170° C. In a shaping pressing tool which is grained, the respective shaped component geometry and at the same time the corresponding surface grain of the decorative layers are produced by means of pressing, blow molding and/or deep-drawing, respectively. In a second step, the edges of the respective decorative layers, where necessary, are cut. In a third step, the respective decorative layers are positioned so as to be orientated with respect to each other and fixed by means of reduced pressure, wherein there is provision in a fourth step for the orientated decorative layers to be moved into a lamination tool and to be laminated with the component carrier at the faces opposite the visible sides.

DE 44 01 903 C1 further discloses a method and a device for laminating a component. In this instance, a lamination film is formed from two film portions which are joined together along a connection seam and which have, for example, different colors or structures. The connection seam of the lamination film is arranged on a rail, which is constructed so as to protrude over a separation region. After adaptation of the lamination film to the structure of surface regions of the component, the regions of the film portions adjacent to the connection seam are separated and the rail is removed. The ends of the film portions are subsequently inserted into the separation region. In another embodiment, the rail is produced integrally with the component and can be removed with the region of the lamination film having the connection seam.

### SUMMARY OF THE INVENTION

The present invention provides, in one aspect, a method at least for partially laminating a component, in particular a vehicle component. The method includes providing a film which is cut to a width which is selected to be slightly larger than a region of the component to be laminated, heating the film at both sides, arranging the film in an upper tool, providing the component with an adhesive, arranging the component in a lower tool, heating the adhesive for activation, and closing the upper tool and the lower tool for pressing the film to the component.

The present invention provides, in another aspect, An apparatus at least for partially laminating a component, in particular a vehicle component, with a film, comprising a tool which is formed from an upper tool and a lower tool, wherein the upper tool and the lower tool are positioned relative to each other, wherein a reduced pressure for fixing the film to be applied to the component is produced by the upper tool, wherein the film has a width which is selected to be slightly larger than the region of the component, which region is intended to be laminated by the film, wherein the film is automatically supplied to a clamping frame and the upper tool is positioned above the clamping frame, wherein the film is fixed to the upper tool with the clamping frame by the reduced pressure produced and the component provided with an adhesive is arranged in the lower tool, wherein the adhesive is heated by a heating device in order to activate it and the tool formed from the upper tool and the lower tool is automatically closed for pressing the film on the component.

An object of the present invention is to provide a method which is improved with respect to the prior art and an improved apparatus for partially laminating a component, in particular a vehicle component, wherein use of material is optimized.

A method according to the invention at least for partially laminating a component, in particular a vehicle component, having a film, makes provision for the film to be cut to a width which is selected to be slightly larger than a region of the component to be laminated, wherein the film is heated at both sides and is arranged in an upper tool and is cut to a size to be used, wherein the component is provided with an adhesive and is arranged in a lower tool, wherein the adhesive is heated for activation and a tool formed from the upper tool and the lower tool is closed for a pressing operation.

By means of the method according to the invention for partially laminating a component, a solution which is cost-effective in comparison with the methods known from the prior art is provided since material use for laminating the component is reduced, that is to say, optimized. When the method is carried out, a comparatively large portion of surface material, in particular film, with which the component is at least partially laminated, can be saved since, for example, there are no occurrences of overlapping of films of different color and/or structure.

In addition, expenditure of time when the component is produced, in particular during lamination, can be reduced since different method steps can be carried out at the same time. For example, it is possible for the film to be heated whilst, at the same time, another component is laminated and/or at the same time a film is in turn cut at least over the width thereof.

In a preferred embodiment, film for lamination is fixed to the upper tool by means of a reduced pressure which is produced, whereby the film is securely retained and the risk of undesirable displacement or slipping is at least reduced.

In a particularly advantageous embodiment, the method makes provision for a film which is intended to be applied to the component to have a width which is selected to be slightly larger than a region of the component, which region is intended to be laminated by means of the film, wherein the film is wound up as a roll and the component is arranged in a lower tool. The film is supplied to a lamination installation, heated at both sides and supplied to a clamping frame. An upper tool is arranged above the clamping frame, wherein a reduced pressure is produced by means of the upper tool, whereby the film is retained in a planar manner on the upper tool and is cut to the dimensions of the region to be laminated. An adhesive is applied to the component arranged in the lower tool, wherein the lower tool is arranged below the upper tool. The adhesive is heated by means of a heating device in order to activate it, wherein the upper tool and the lower tool are closed as a tool, whereby the film is arranged and pressed on the component provided with the adhesive.

By means of this particularly advantageous embodiment of the method, the partial lamination of the component is in comparison even further improved and the use of material is optimized.

Preferably, the film is automatically cut to a size to be used by means of a punching blade in the clamping frame. The cutting of the film is in this instance advantageously carried out whilst the clamping frame is positioned on the upper tool, whereby time can be saved during the lamination.

The invention further relates to an apparatus for partially laminating a component, in particular a vehicle component, such as, for example, a component of a vehicle door or an instrument carrier panel.

The apparatus has a tool which is formed from an upper tool and a lower tool, wherein the upper tool and the lower tool can be positioned relative to each other, wherein a reduced pressure for fixing the film to be applied to the component can be produced by means of the upper tool, wherein the film has a width which is selected to be slightly larger than the region of the component, which region is intended to be laminated by means of the film, wherein the film can be automatically supplied to a clamping frame and the upper tool can be positioned above the clamping frame, wherein the film can be fixed to the upper tool with the clamping frame by means of the reduced pressure produced and the component provided with an adhesive can be arranged in the lower tool, wherein the adhesive can be heated by means of a heating device in order to activate it and the tool formed from the upper tool and the lower tool can be automatically closed for a pressing operation of the film on the component.

Using an apparatus constructed in such a manner, partial lamination of a component can be carried out in a manner automated to the greatest possible extent, wherein it is particularly advantageously possible to carry out various operations on a plurality of components which are intended to be at least partially laminated.

In a preferred embodiment of the invention, the clamping frame has a punching blade by means of which the film can automatically be cut to a size to be used. As a result of the automated cutting of the film, manual handling of the film and/or the punching blade is not necessary so that it is possible to at least save time when the component is laminated.

In order to automatically cut the film, the upper tool has a groove in accordance with the size of the film to be used, wherein the punching blade can be guided in the groove. In this instance, the groove is introduced into the upper tool in such a manner that the film has precise dimensions with respect to the region to be laminated and the cutting can be repeated as often as desired. It is thereby particularly advantageous to use the apparatus in a production environment of series production, for example, of vehicle doors.

In another preferred embodiment of the apparatus, the upper tool and/or the lower tool can be heated so that the film can be heated by means of the upper tool and/or the component can be heated with the adhesive in order to activate it. An additional heating device would therefore not be required, whereby costs of the apparatus can be saved.

With reference to the schematic figures appended, the invention is explained in greater detail with reference to embodiments.

### BRIEF DESCRIPTION OF THE DRAWINGS

FIG. 1 is a schematic view of a component of a vehicle door having partially applied film for lamination,

FIG. 2 is a schematic view of a lamination installation at the beginning of a method for partial lamination of the component,

FIG. 3 is a schematic view of a first method step for partial lamination,

FIG. 4 is a schematic view of a second method step for partial lamination,

FIG. 5 is a schematic view of a third method step for partial lamination, and

FIG. 6 is a schematic side view of the lamination installation.

Components which correspond to each other have been given the same reference numerals in all the figures.

### DETAILED DESCRIPTION

FIG. 1 shows a component 1 as a carrier member of a vehicle door with a partially applied film 2 for laminating a region 1.1 of the component 1.

Alternatively, the component 1 may also be an instrument carrier panel of a vehicle.

The lamination is used as a method technique in order to construct the component 1 in a variety of colors and/or to provide it with different decorations.

For lamination, a film 2 is used which is formed, for example, from olefin-based thermoplastic elastomers (TPEO) and/or from thermoplastic polyurethane and/or from polyvinyl chloride.

The component 1 may have a plurality of regions 1.1 to be laminated which may, for example, be separated from each other by means of a groove. For example, a region 1.1 to be laminated is a map pocket region, a central field and/or a so-called bodywork strip.

If a region 1.1 of the component is laminated by means of the film 2, there is provision for an end of the film 2 facing the groove to be arranged in the groove after lamination and consequently at least not to be visible.

FIG. 2 shows an apparatus for partially laminating the component 1 of the vehicle door with a film 2. The film 2 has a width which is selected to be slightly larger than the dimensions of the region 1.1 of the component 1 to be laminated, wherein the film 2 is wound up as a roll.

The apparatus which can also be referred to as a lamination installation has a conveying device 3 for the film 2, a tool which is formed by means of an upper tool 4 and a lower tool 5, a clamping frame 6 and a film heating device 7. In this instance, the upper tool 4 and the lower tool 5 can be heated.

The film heating device 7 is preferably constructed in two pieces so that the film 2 which can be moved by means of the conveying device 3 can be heated both from above and from below.

A portion of the film 2 which is heated by means of the film heating device 7 is supplied by means of the conveying device 3 to the clamping frame 6 by means of which the film 2 is clamped, wherein this first method step is shown in FIGS. 3 and 4.

As described above, the upper tool 4 can be heated and is moved in a second method step in the direction of the clamping frame 6, as illustrated in FIG. 5 as a second method step. An inner contour of the upper tool 4 in this instance corresponds to a contour of the region 1.1 of the component 1, which region is intended to be laminated, as shown in greater detail in FIG. 6.

Using the upper tool 4, a reduced pressure can be produced so that the film 2 can be drawn in by the upper tool 4 and is retained on the upper tool 4.

There is formed in the upper tool 4, at the edge side in a peripheral manner, a groove 4.1 which is shown in greater detail in FIG. 6 and which is also referred to as a groove channel in which a punching blade which is not illustrated in greater detail is guided, so that the film 2 can be cut to the dimensions of the region 1.1 of the component 1 to be adhesively bonded. In this instance, the punching blade is, for example, in the clamping frame 6, at or on which the film 2 is arranged.

During the cutting operation, in particular punching of the film 2 and after the punching operation, the film 2 is further retained on the upper tool 4 by means of reduced pressure.

In a third method step, which is illustrated in FIG. 6, the upper tool 4 moves back into its original position and is consequently located above the lower tool 5 with the component 1.

The component 1 arranged in the lower tool 5 is provided, in particular sprayed, in the region 1.1 to be laminated with an adhesive 8 shown in FIG. 6, wherein the adhesive 8 and the film 2 are heated by means of the upper tool 4 and the lower tool 5.

Alternatively, at least one separate heating device may be provided, by means of which the adhesive 8 and/or the component 1 and/or the film 2 can be heated.

During the activation of the adhesive 8 by means of the lower tool 5, the film 2 is heated by means of the upper tool 4 at the same time.

The upper tool 4 and the lower tool 5 are closed, wherein the upper tool 4 and the lower tool 5 are arranged directly one on the other and the component 1 with the adhesive 8 and the film 2 are located therebetween.

As a result of the fact that the upper tool 4 and the lower tool 5 are closed as a tool, the film 2 is secured to, and pressed on, the provided region 1.1 of the component 1 in a materially engaging manner, whereby the region 1.1 is laminated.

The component 1 with the film 2 applied is subjected to a cooling process, wherein the lamination operation has already ended. After the cooling, the upper tool 4 and the lower tool 5 are moved apart so that the component 1 can be removed.

Individual method steps for partially laminating a region 1.1 of a component 1 may in a particularly preferred manner be constructed in a parallel manner, that is to say, at the same time. It is thus possible, for example, during the heating of the film 2, for another component 1 to be laminated, but also for the clamping frame 6 to be able to be equipped.

It is also conceivable that, with a similar door trim, a left-hand and a right-hand vehicle door can be partially laminated at the same time.

FIG. 6 is a side view of the apparatus at least for partial lamination of a component 1.

Various features of the invention are set forth in the following claims.

1. A method at least for partially laminating a component, in particular a vehicle component, comprising:
providing a film which is cut to a width which is selected to be slightly larger than a region of the component to be laminated;
heating the film at both sides;
arranging the film in an upper tool;
providing the component with an adhesive;
arranging the component in a lower tool;
heating the adhesive for activation; and
closing the upper tool and the lower tool for pressing operation the film to the component.

2. The method as claimed in claim 1, further comprising fixing the film to the upper tool by a reduced pressure produced in the upper tool.

3. The method as claimed in claim 1, wherein the film is wound up as a roll, wherein the film is automatically supplied to a clamping frame, wherein the upper tool is arranged above the clamping frame and the film is retained in a planar manner on the upper tool and is cut to the dimensions of the region to be laminated, wherein the adhesive is applied to the component arranged in the lower tool, and wherein the lower tool is arranged below the upper tool and the adhesive is heated by a heating device in order to activate it.

4. The method as claimed in claim 3, wherein the film is automatically cut to a size to be used by a punching blade in the clamping frame.

5. An apparatus at least for partially laminating a component, in particular a vehicle component, with a film, comprising a tool which is formed from an upper tool and a lower tool, wherein the upper tool and the lower tool are positioned relative to each other, wherein a reduced pressure for fixing the film to be applied to the component is produced by means of the upper tool, wherein the film has a width which is selected to be slightly larger than the region of the component, which region is intended to be laminated by the film, wherein the film is automatically supplied to a clamping frame and the upper tool is positioned above the clamping frame, wherein the film is fixed to the upper tool with the clamping frame by the reduced pressure produced and the component provided with an adhesive is arranged in the lower tool, wherein the adhesive is heated by a heating device in order to activate it and the tool formed from the upper tool and the lower tool is automatically closed for pressing the film on the component.

6. The apparatus as claimed in claim 5, wherein the clamping frame has a punching blade, and wherein the film is automatically cut by the punching blade to a size to be used.

7. The apparatus as claimed in claim 6, wherein the upper tool has a groove in accordance with the size of the film to be used, and wherein the punching blade is guided in the groove in order to cut the film.

8. The apparatus as claimed in claim 5, wherein at least one of the upper tool and the lower tool is heated.

9. The method as claimed in claim 2, wherein the film is wound up as a roll, wherein the film is automatically supplied to a clamping frame, wherein the upper tool is arranged above the clamping frame and the film is retained in a planar manner on the upper tool and is cut to the dimensions of the region to be laminated, wherein the adhesive is applied to the component arranged in the lower tool, and wherein the lower tool is arranged below the upper tool and the adhesive is heated by a heating device in order to activate it.

10. The apparatus as claimed in claim 6, wherein at least one of the upper tool and the lower tool is heated.

11. The apparatus as claimed in claim 7, wherein at least one of the upper tool and the lower tool is heated.
